(19) United States
(12) Patent Application Publication
(10) Pub. No.: US 2016/0054063 A1
(43) Pub. Date: Feb. 25, 2016

(54) CONTROLLER

(71) Applicant: Azbil Corporation, Tokyo (JP)

(72) Inventors: Tadanao TANI, Tokyo (JP); Atsushi TAKAHASHI, Tokyo (JP)

(73) Assignee: Azbil Corporation, Tokyo (JP)

(21) Appl. No.: 14/819,802

(22) Filed: Aug. 6, 2015

(30) Foreign Application Priority Data
Aug. 22, 2014 (JP) 2014-169177

(51) Int. Cl. F27D 19/00; G05B 19/408

(52) U.S. Cl. CPC F27D 19/00; G05B 19/408; F27D 2019/0034; F27D 2019/0056; F27D 2019/009; G05B 2219/45132

(57) ABSTRACT

The controller according to the present invention includes an identifying information storing portion for storing unique identifying information; a non-contact communicating portion for receiving, through near-distance radio communication, identifying information for a controller and control parameters that indicate control conditions for a controlled device; a control parameter storing portion, an evaluating portion for evaluating whether or not there is a match between identifying information that has been received and identifying information that is stored in the identifying information storing portion; and a writing controlling portion, wherein: when there is a match between the identifying information that has been received and the identifying information that is stored in the identifying information storing portion, the writing controlling portion writes the received control parameters to the control parameter storing portion, and, if there is no match, does not write the received control parameters to the control parameter storing portion.

### CROSS REFERENCE TO RELATED APPLICATION

This application claims priority under 35 U.S.C. §119 to Japanese Patent Application No. 2014-169177, filed on Aug. 22, 2014, the entire content of which is being hereby incorporated herein by reference.

### FIELD OF TECHNOLOGY

The present invention relates to a controller for adjusting a process variable, such as temperature, and, in particular, relates to a controller able to receive data through radio communication.

### BACKGROUND

Typically controllers for controlling process variables, such as temperature, are combined together with manufacturing apparatuses for manufacturing, such as in industrial process product. The controller monitors the state of a controlled device, to control heaters, valves, or the like, that are provided within the control device or on the outside, to cause the controlled device to go to a target state. For example, Japanese Unexamined Patent Application Publication 2009-53044 (the “JP '044”), discloses a temperature controller for carrying out control as to cause the controlled device to go to a target temperature, to carrying out PID (Proportional Integral Derivative) calculations based on temperature detection results for the controlled device, detected by a temperature sensor.

In such a controller, control parameters indicating control conditions (for example, the target temperature, heating time, or the like) for controlling the controlled device are set in advance, and various types of control are carried out in accordance with the control parameters that have been set.

The method for setting the control parameters in a conventional controller may be, for example, a method wherein an operator, or the like, manually inputs the values for the control parameters through operating a controller console while viewing a display on a monitor that is attached to the controller, or a method wherein the control parameters are set in the controller through connecting, via a communication cable, to the controller, a terminal (such as a personal computer) wherein dedicated software (a “PC loader”), for writing and reading out control parameters, and the like, is installed, and an operator, or the like, executing the PC loader on the terminal.

However, in the method described above using manual operations by an operator, or the like, the operator, or the like, manually inputs the control parameters into each individual controller, which is time-consuming, and there are problems in that inputting of control parameters is prone to error.

On the other hand, in the method described above wherein a PC loader is used, despite being able to reduce the time required for inputting the control parameters through the operator, or the like, operating the controller console, if, for example, controllers of a plurality of types (models) are installed in a manufacturing apparatus, for example, then it would be necessary to develop PC loaders corresponding to each individual model, and these would have to be installed in the terminal, and thus there is a problem in that this may lead to increased costs.

Given this, the inventors in the present application, prior to the invention of the present application, researched setting of control parameters, or the like, that are stored in a non-contact IC tag, into the controller through near-distance radio communication.

Specifically, when controlling, through a temperature controller, a prescribed heat treatment in a production manufacturing step, a non-contact IC tag, whereon is stored, as control parameters, the control parameters that are optimal for that heat treatment (the target temperature, heating time, and the like), is attached in advance to the object that is to be subjected to the heat treatment (for example, the raw material for production, or the like), or to a pallet for carrying the material that is to be processed. Given this, when the heat treatment is carried out, the operator removes the non-contact IC tag that is attached to the material that is to be processed, or to the pallet, or the like, and causes the temperature controller that controls the heat treatment to read in the non-contact IC tag, to set the control parameters.

The control parameters are set up in the regulator through reading in the non-contact IC tag. Doing so eliminates the manual inputting by the operator, or the like, and the PC loader.

However, the method described above that uses the non-contact IC tag has problems such as the following. For example, for a manufacturing apparatus that carries out heat treatments of a plurality of different types, there will be multiple combinations of heat treatment furnaces and controllers. In such a manufacturing apparatus, the consoles for all of the controllers may be disposed together in one location in order to facilitate easy monitoring and operation of the controllers by an operator, or the like. In such a case, when the operator causes the controller to read the non-contact IC tag, there is a risk that the information in the non-contact IC tag may be read out in error by a nearby controller.

The present invention was created in order to eliminate problem areas such as set forth above, and the aspect thereof is to enable setting of information from the non-contact IC tag into only a targeted controller.

### SUMMARY

A controller according to the present invention includes an identifying information storing portion that stores unique identifying information; a non-contact communicating portion that receives, through radio communication, a control parameter indicating a control condition for a controlled device and identifying information for a controller that is to control the controlled device based on the control parameter; a control parameter storing portion that stores the control parameter; a control signal generating portion that generates a control signal that controls the controlled device based on the control parameter stored in the control parameter storing portion; an evaluating portion that evaluates whether or not identifying information received by the non-contact communicating portion matches identifying information stored in the identifying information storing portion; and a writing controlling portion that controls writing to the control parameter storing portion of the control parameter received by the non-contact communicating portion. The writing controlling portion writes, to the control parameter storing portion, the control parameter received by the non-contact communicating portion if the identifying information received through the non-contact communicating portion matches identifying information stored in the identifying information storing portion, and does not write, to the control parameter storing portion, the control parameter received through the non-contact communicating portion if the identifying information that is stored in the identifying information storing portion does not match the identifying information received through the non-contact communicating portion.

Another controller according to the present invention includes an identifying information storing portion that stores unique identifying information; a control parameter storing portion that controls storing of a control parameter indicating a control condition for a controlled device; a control signal generating portion that generates a control signal that controls the controlled device based on the control parameter stored in the control parameter storing portion; a communicating portion that carries out radio communication with an external device; and a communication controlling portion that controls communication through the communicating portion, and that controls writing, to the control parameter storing portion, of the data received through the communicating portion. The communication controlling portion transmits the identifying information, stored in the identifying information storing portion, through the communicating portion, and, when a control parameter is received as a response to the transmission of the identifying information, writes the received control parameter into the control parameter storing portion.

Given the explanation set forth above, the present invention enables the information from the non-contact IC tag to be set in only a targeted controller.

### BRIEF DESCRIPTIONS OF THE DRAWINGS

Note that the reference codes in the explanations below are no more than illustrative examples that are included in the concepts of the structural elements, to which the reference codes have been assigned in the drawings.

FIG. 1 illustrates the structure of a manufacturing apparatus provided with a controller according to an Example.

FIG. 2 is a diagram for explaining a method for setting control parameters in the controller according to the Example.

FIG. 3 is a diagram illustrating an internal structure for a controller according to the Example.

FIG. 4 is a diagram illustrating the procedure when setting a control parameter DP, which has been read out from a non-contact IC tag, into a controller according to the Example.

FIG. 5 is a diagram for explaining a method for setting a control parameter in a controller according to Another Example.

FIG. 6 is a diagram illustrating the internal structure of a mobile terminal for carrying out reading of the non-contact IC tag.

FIG. 7 is a diagram illustrating an internal structure for a controller according to the Another Example.

FIG. 8 is a diagram illustrating a procedure when setting, to a controller according to the Another Example, a control parameter that has been stored in a non-contact IC tag, using a mobile terminal.

FIG. 9 is a diagram illustrating a specific processing procedure of FIG. 8.

### DETAILED DESCRIPTION

Forms for carrying out the present disclosure will be explained below in reference to the figures.

### Example

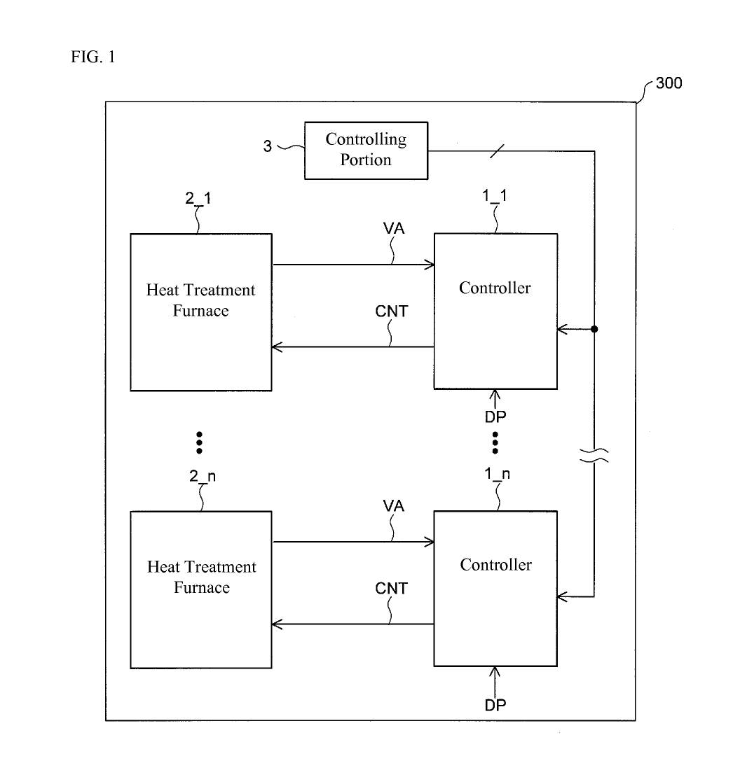

FIG. 1 is a diagram illustrating a structure of a manufacturing apparatus 300 comprising a controller according to an Example according to the present invention.

The manufacturing apparatus 300 illustrated in this figure is an apparatus for manufacturing industrial process product, installed within a factory, an apparatus for manufacturing a desired product through, for example, machining metal materials, performing heat treatments, or the like. FIG. 1 illustrates an instrument for achieving the heat treating step, from among a plurality of instruments that structure the manufacturing apparatus 300.

Specifically, the manufacturing apparatus 300 includes a plurality of heat treatment furnaces 2_1 to 2_n (where n is an integer no less than 2), a plurality of controllers 1_1 to 1_n, and a controlling portion 3, as the instruments for carrying out the heat treating step.

The heat treatment furnaces 2_1 to 2_n have containers (for example, a vacuum furnaces) for storing the material that is to be subjected to heat treatment, and are devices for heating and cooling the metal material, or the like, that is loaded into the containers. In the heat treatment furnaces 2_1 through 2_n, the process variables for the heat treatment (the heating temperature, going temperature, heating time, cooling time, and the like) are controlled by control signals CNT that are applied by the corresponding controllers 1_1 to 1_n.

The controlling portion 3 carries out overall control of the manufacturing apparatus 300. For example, the controlling portion 3 controls the execution and stopping, and the like, of the heat treatment by the heat treatment furnaces 2_1 to 2_n through controlling the controllers 1_1 to 1_n.

The controllers 1_1 to 1_n are devices for monitoring the states of the heat treatment furnaces 2_1 to 2_n, as controlled devices, and for controlling, through control signals CNT, the heat treatments by the heat treatment furnaces 2_1 to 2_n. The controllers 1_1 to 1_n are, for example, temperature controllers. Specifically, the controllers 1_1 to 1_n are set with control parameters DP that indicate the control parameters for controlling the heat treatment furnaces 2_1 to 2_n (for example, target temperatures, heating times, and the like), to generate control signals CNT through carrying out PID calculations based on the control parameters DP that have been set and the detection results VA for the temperatures within the heat treatment furnaces 2_1 to 2_n, to controlled the corresponding heat treatment furnaces 2_1 to 2_n through the control signals CNT.

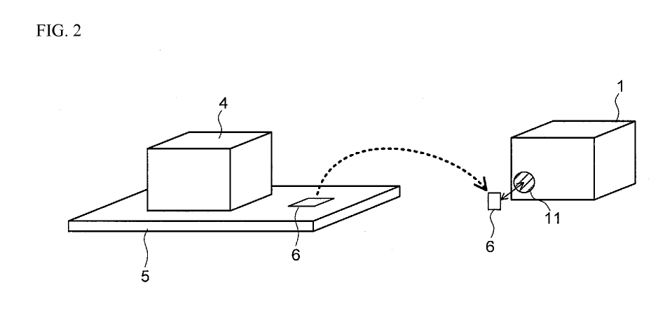

FIG. 2 is a diagram for explaining a method for setting control parameters in the controller according to the Example. Note that in the explanation below, when the controllers 1_1 to 1_n are referenced in general, they are written as a “controller 1,” and when the heat treatment furnaces 2_1 to 2_n are referenced in general, they are written as a “heat treatment furnace 2.”

As illustrated in this figure, the controller 1 has a non-contact communicating portion 11 for carrying out near-distance radio communication, enabling information that is recorded on the non-contact IC tag 6 to be read out through the non-contact communicating portion 11.

The non-contact IC tag 6 can be an RFID (Radio Frequency Identifier), and stores the control parameters DP and identifying information for the controller for which those control parameters DP are to be set.

Here the identifying information refers to information for identifying the controller that is provided in the manufacturing apparatus 300. The identifying information is, for example, the instrument number that is assigned for each individual instrument that structures the manufacturing apparatus 300. Specifically, when, for example, serial numbers of “1,” “2,” . . . , “m” are assigned as instrument numbers to all of the controllers 1_1 to 1_n or heat treatment furnaces 2_1 to 2_n, or the like, that structure the manufacturing apparatus 300, then those numbers are stored in the non-contact IC tags 6 as identifying information. For example, information for the instrument number for the controller 1_1 and for the control parameters DP that are to be set in the controller 1_1 are stored in the non-contact IC tag 6 for the controller 1_1.

In the explanation below, the identifying information for the controller, stored in the non-contact IC tag 6, will be known as “identifying information ID_T”.

The non-contact IC tag 6 is attached in advance to a container (box) that contains the metal material 4 that is to be subjected to the heat treatment by the heat treatment furnace 2, or attached to a pallet 5, or the like, for carrying the metal material 4.

When the heat treatment for the metal material 4 is to be carried out by the heat treatment furnace 2, the operator can remove the non-contact IC tag 6 that is attached to the pallet 5, or the like, and can cause the controller 1 that controls the heat treatment furnace 2 to read in the non-contact IC tag 6, to thereby set the control parameters DP in the controller 1. At this time, the controller 1 sets the control parameters DP that have been read in from the non-contact IC tag 6 only if the identifying information ID_T that is stored in the non-contact IC tag 6 matches the identifying information that is stored within the controller 1. The controller 1 will be explained in detail below.

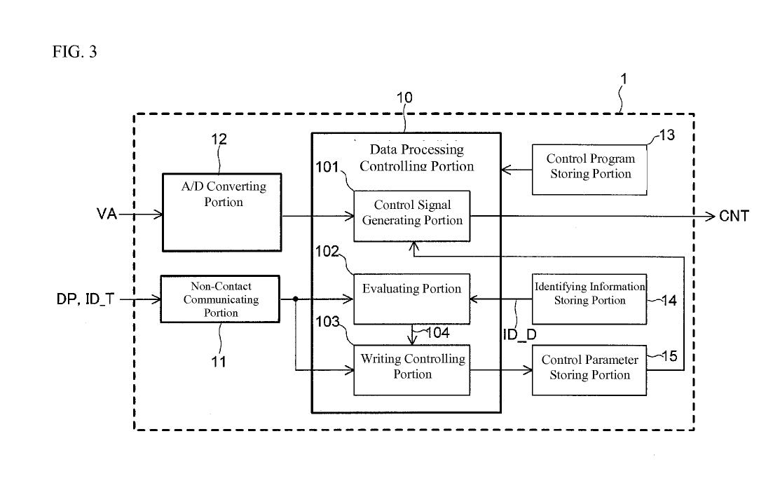

FIG. 3 is a diagram illustrating an internal structure for a controller according to the Example.

As illustrated in this figure, the controller 1 comprises a data processing controlling portion 10, a non-contact communicating portion 11, an A/D converting portion 12, a control program storing portion 13, an identifying information storing portion 14, and a control parameter storing portion 15.

The A/D converting portion 12 is an A/D converting circuit for converting into a digital signal a detection signal (analog signal) VA from a sensor for detecting, for example, the temperature within a heat treatment furnace 2.

The non-contact communicating portion 11 is a functional portion for carrying out near-distance radio communication with the outside, and is structured from, for example, an antenna, an RF circuit for sending and receiving data through the antenna, and the like. NFC (Near-Field Communication) can be used as an illustrative example of this near-distance radio communication. The non-contact communicating portion 11 carries out communication with, for example, the non-contact IC tag 6 following the NFC standard. Specifically, when the non-contact IC tag 6 is brought into proximity with the data reading portion (for example, an antenna) of the non-contact communicating portion 11, the non-contact communicating portion 11 receives, through near-distance radio communication, the identifying information ID_T and the control parameters DP that are stored in the non-contact IC tag 6. The identifying information ID_T and control parameters DP that have been received are sent to the data processing controlling portion 10.

A control program that is executed by the data processing controlling portion 10 is stored in the control program storing portion 13.

Identifying information for the controller 1 is stored in the identifying information storing portion 14. Here the identifying information that is stored in the identifying information storing portion 14 is similar to the identifying information that is stored in the non-contact IC tag 6, being, for example, an instrument number that is assigned for each instrument that structures the manufacturing apparatus 300. For example, the instrument number of the controller 1_1 is stored as the identifying information in the identifying information storing portion 14 of the controller 1_1. In the explanation below, the identifying information for the controller that is stored in the identifying information storing portion 14 is referred to as “identifying information ID_D”.

The control parameters DP are stored in the control parameter storing portion 15. As described above, the control parameters DP are data indicating the control parameters for controlling the heat treatment furnace 2 as the controlled device. For example, when the controller 1 carries out PID control, the control parameters DP are data including the target value (SP) for the temperature, and set points for the proportional band, integrating time, differentiating time, manipulated variable lower limit value, manipulated variable upper limit value, and upper limit warning point, and the like, for PID control.

The control program storing portion 13, identifying information storing portion 14, and control parameter storing portion 15 are structured from, for example, a rewritable non-volatile storing device such as an EEPROM (Electrically Erasable Programmable Read-Only Memory), flash memory, or the like. The data processing controlling portion 10 can deploy into a RAM (Random Access Memory), not shown, the data that are stored in the control program storing portion 13, identifying information storing portion 14, and control parameter storing portion 15, and carries out various types of calculating processes using the deployed data.

The data processing controlling portion 10 is a functional portion for carrying out overall control of the controller 1, for example, a program processing device such as a CPU, or the like. The data processing controlling portion 10 functions as a control signal generating portion 101, an evaluating portion 102, and a writing controlling portion 103, through carrying out the program procedures following the control programs that are stored in the control program storing portion 13.

The control signal generating portion 101 generates control signals CNT so as to optimize the process variables (the heating temperature, heating time, and the like) of the heat treatment by the heat treatment furnace 2, through carrying out PID calculations based on the A/D conversion result (a digital signal) of the detection signal VA by the A/D converting portion 12, and on the control parameters DP that are recorded in the control parameter storing portion 15.

The evaluating portion 102 evaluates whether or not there is a match between the identifying information ID_T that was received through the non-contact communicating portion 11 and the identifying information ID_D that is stored in the identifying information storing portion 14, and outputs the evaluation results 104.

The writing controlling portion 103 controls writing of the control parameters DP to the control parameter storing portion 15 based on the evaluation result 104 by the evaluation controlling portion 102. Specifically, if the identifying information ID_T received by the non-contact communicating portion 11 matches the identifying information ID_D that is stored in the identifying information storing portion 14, then the control parameters DP receive through the non-contact communicating portion 11 will be written to the control parameter storing portion 15, but if there is no match between the identifying information ID_T and the identifying information ID_D, then the control parameters DP received through the non-contact communicating portion 11 will not be written to the control parameter storing portion 15.

The procedure when setting the control parameters DP, read from the non-contact IC tag 6, to the controller according to the Example will be explained next.

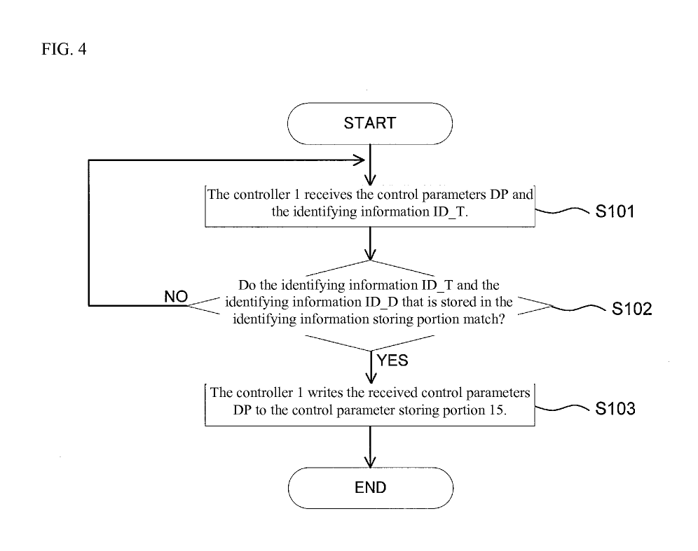

FIG. 4 is a diagram illustrating the procedure when setting a control parameter DP, which has been read out from a non-contact IC tag 6, into a controller according to the Example.

For example, when the operator removes the non-contact IC tag 6 that is attached to the pallet 5, or the like, of the metal material 4 that is subject to the heat treatment and brings the non-contact IC tag 6 into proximity with the non-contact communicating portion 11 of the controller 1, the controller 1 carries out near-distance radio communication with the non-contact IC tag 6, to receive the control parameters DP and the identifying information ID_T (S101). Following this, the controller 1, through the evaluating portion 102, evaluates whether or not there is a match between the identifying information ID_T that has been received and the identifying information ID_D that is stored in the identifying information storing portion 14 (S102).

If, in Step S102, the identifying information ID_T and the identifying information ID_D do not match, then the controller 1 first goes into standby, while maintaining a state wherein it can read the non-contact IC tag 6, without writing, to the control parameter storing portion 15, the control parameters DP received together with the identifying information ID_T.

If, in Step S102, the identifying information ID_T and the identifying information ID_D match, then the controller 1 writes, to the control parameter storing portion 15, the control parameters DP received together with the identifying information ID_T (S103). The control parameters DP in the controller 1 thereby.

The controller 1 according to the Example, described above, is able to set the control parameters through reading in the information of the non-contact IC tag, thereby eliminating the need for the manual input by the operator and the PC loader, such as is conventional, thereby enabling a reduction in operator time and a reduction in costs.

Moreover, with the controller according to the Example, the control parameters and identifying information are received from the non-contact IC tag, and the control parameters that have been received from the non-contact IC tag are written to the controller only if the identifying information that has been received matches identifying information that is stored within the controller, thus making it possible to set the information from the non-contact IC tag in only the targeted controller. This makes it possible to prevent the operator from causing the information from the non-contact IC tag to be read in erroneously to another controller when consoles for a plurality of controllers are arranged together in one place.

### Another Example

In the controller according to Another Example, the point that near-distance radio communication is carried out with a mobile terminal that reads the information from the non-contact IC tag, rather than carrying out communication directly with the non-contact IC tag, and the point that, rather than having an evaluating portion, identifying information is sent to the mobile terminal itself, described above, through near-distance radio communication, and the control parameters that are received in response to this transmission are stored in an internal storage portion, differ from the controller according to the Example, where the other points are similar to the controller according to the Example.

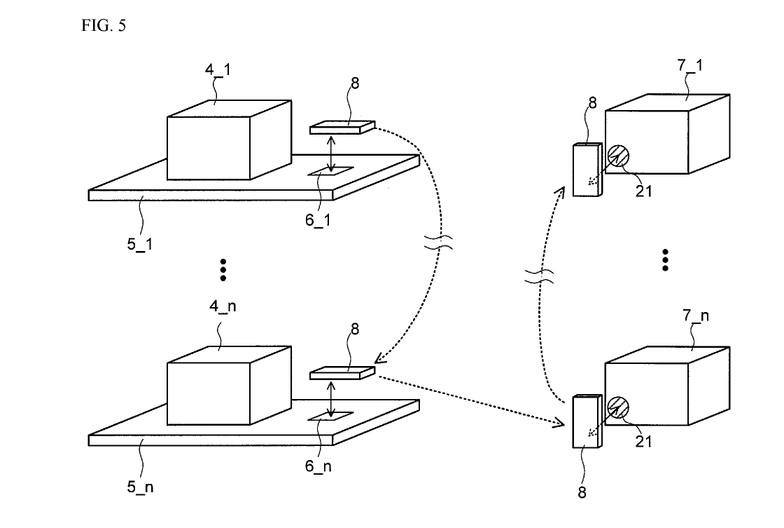

FIG. 5 is a diagram for explaining a method for setting control parameters in the controller according to the Another Example.

As illustrated in FIG. 5, the controllers 7_1 to 7_n according to the Another Example have communicating portions 21, enabling radio communication with a mobile terminal 8 to be carried out through the communicating portions 21.

The mobile terminal 8 is provided with a function as a reader/writer for the non-contact IC tags 6_1 to 6_n, and a function for carrying out radio communication with the controllers 7_1 through 7_n. Tablet terminals, smart phones, and the like, can be listed as examples of mobile terminals 8.

As illustrated in FIG. 5, for each of the heat treatments by the heat treatment furnaces 2_1 to 2_n, the metal materials 4_1 to 4_n that are to be subjected to the heat treatments are determined, and respective non-contact IC tags 6_1 to 6_n are attached to the pallets 5_1 to 5_n on which the respective metal materials 4_1 through 4_n are placed. At this time, the instrument numbers (identifying information) ID_T for the controllers 7_1 to 7_n for controlling the heat treatments of the metal materials 4_1 to 4_n, and the control parameter DP information to be sent into the controllers 7_1 to 7_n are stored in the non-contact IC tags 6_1 to 6_n.

At the commencement of the heat treatments for the metal materials 4_1 to 4_n by the heat treatment furnaces 2_1 to 2_n, after the operator has first read in the control parameters DP and identifying information, stored in the non-contact IC tags 6_1 to 6_n sequentially, in advance, through the mobile terminal 8, communication is then carried out between the mobile terminal 8 and the individual controllers 7_1 to 7_n, making it possible to set the control parameters DP into the individual controllers 7_1 through 7_n. The controllers 7 and the mobile terminal 8 will be explained in detail below.

Note that in the explanation below, the controllers 7_1 to 7_n, when referred to in general, are referred to as a “controller 7,” and when the non-contact IC tags 6_1 to 6_n are referred to in general, they are referred to as a “non-contact IC tag 6.”

As illustrated in this figure, the controller 7 has a non-contact communicating portion 21 for carrying out near-distance radio communication, enabling information that is recorded on the non-contact IC tag 6 to be read out through the non-contact communicating portion 21.

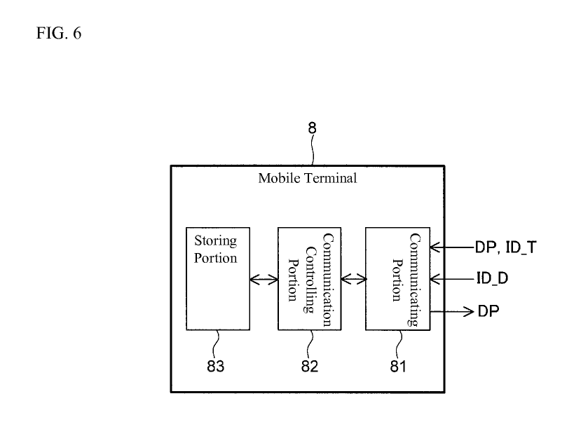

FIG. 6 is a diagram illustrating the internal structure of a mobile terminal for carrying out reading of the non-contact IC tag. Note that in this figure, of those plurality of functional portions of the mobile terminal 8, only those functional portions that achieve communication between the non-contact IC tags 6_1 to 6_n and the controllers 7_1 to 7_n are shown.

As illustrated in FIG. 6, the mobile terminal 8 can comprise at least a communication controlling portion 82, a communicating portion 81, and a storing portion 83.

The communicating portion 81 is a functional portion for both carrying out near-distance radio communication (for example, NFC) with the non-contact IC tag 6, and carrying out radio communication that is near-distance radio communication (for example, NFC) with the controller 7, and is structured from an antenna, RF circuitry, and the like.

The storing portion 83, identifying information storing portion 14 is structured from, for example, a rewritable non-volatile storing device such as an EEPROM, flash memory, or the like.

The communication controlling portion 82 not only controls the communication through the communicating portion 81, but also controls writing, to the storing portion 83, of the data received through the communicating portion 81, and reading out of data from the storing portion 83. The communication controlling portion 82 is achieved through, for example, a program procedure by a program processing device, such as a CPU, or the like.

The communication controlling portion 82 receives the identifying information ID_T and control parameters DP from the non-contact IC tag 6 through the communicating portion 81, and defines the relationship between the identifying information ID_T and the control parameters DP that have been received, writing them to the storing portion 83.

Moreover, the communication controlling portion 82 receives the identifying information ID_D from the controller 7, through the communicating portion 81, and evaluates whether or not identifying information ID_T that matches the received identifying information ID_D is stored in the storing portion 83. If the evaluation result is that identifying information ID_T that matches the identifying information ID_D is stored, then the communication controlling portion 82 reads out, from the storing portion 83, the control parameters DP corresponding to that identifying information ID_T. Following this, the communication controlling portion 82 sends, through the communicating portion 81 in response to the transmission of the identifying information ID_D by the controller 7, the control parameters DP that have been read out from the storing portion 83.

On the other hand, if no identifying information ID_T that matches the identifying information ID_D is stored, then the communication controlling portion 82 informs the user, such as an operator, that there is an error. For example, an error screen may be displayed on a displaying device (not shown) of the mobile terminal 8, or audio may be outputted from a speaker (not shown) of the mobile terminal 8, to notify the user, such as an operator, or the like, that there is an error.

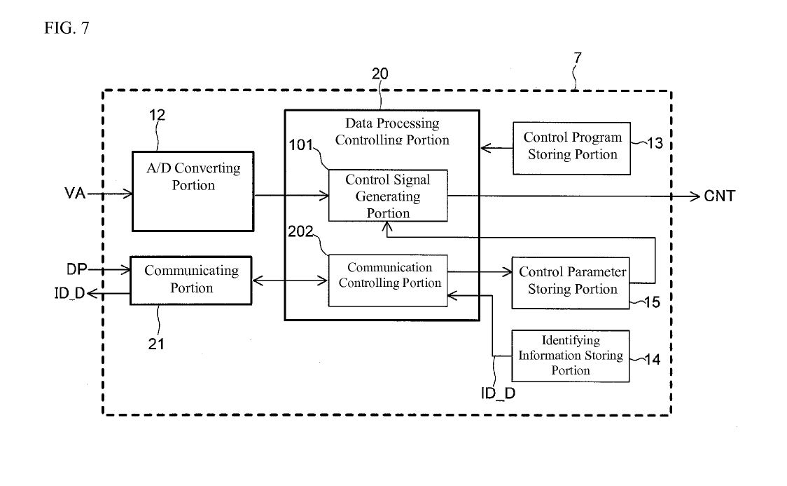

FIG. 7 is a diagram illustrating an internal structure for a controller according to the Another Example. Note that structural elements in the controller 7 according to the Another Example that are identical to those in the controller 1 according to the Example are assigned identical codes, and detailed explanations thereof are omitted.

As illustrated in FIG. 7, the controller 7 comprises a data processing controlling portion 20, a communicating portion 21, an A/D converting portion 12, a control program storing portion 13, an identifying information storing portion 14, and a control parameter storing portion 15.

The communicating portion 21 is structured from functional portions for carrying out communication with the mobile terminal 8, structured from, for example, an antenna and RF circuitry, and the like.

The data processing controlling portion 20, as with the data processing controlling portion 10, is a functional portion that carries out overall control of the controller 7, and is structured from a program processing device such as a CPU, or the like. The data processing controlling portion 20 functions as a control signal generating portion 101, and a communication controlling portion 202, through carrying out the program procedures following the control programs that are stored in the control program storing portion 13.

The communication controlling portion 202 not only controls communication through the communicating portion 21, but also controls writing and reading out of data to/from the control parameter storing portion 15 and the identifying information storing portion 14. Specifically, the communication controlling portion 202 reads out the identifying information ID_D that is stored in the identifying information storing portion 14 and sends it through the communicating portion 21. Moreover, the communication controlling portion 202 receives, through the communicating portion 21, the control parameters DP that are sent from the mobile terminal 8 in response to the transmission of the identifying information ID_D, and writes those control parameters DP to the control parameter storing portion 15.

The procedure when using a mobile terminal 8 to set, in the controller 7, the control parameters DP that are stored in the non-contact IC tag 6 will be explained next.

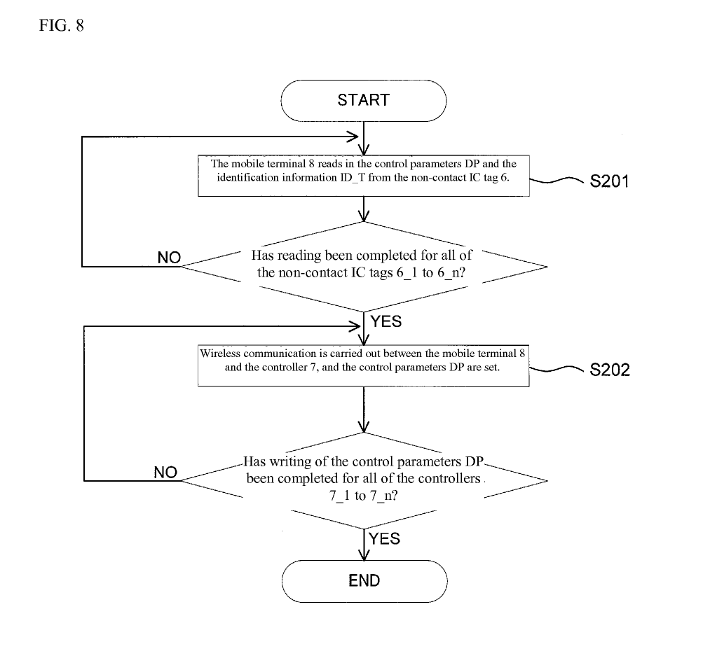

FIG. 8 is a diagram illustrating a procedure when setting, to a controller according to the Another Example, a control parameter that has been stored in a non-contact IC tag, using a mobile terminal.

First the operator brings the mobile terminal 8 into proximity with the non-contact IC tag 6 that is attached to the pallet 5 whereon the metal material 4 that will be subject to the heat treatment is placed, to cause the identifying information ID_T and control parameters DP that are stored in the non-contact IC tag 6 to be read into the mobile terminal 8 (S201). Specifically, the operator sequentially brings the mobile terminal 8 into proximity to all of the non-contact IC tags 6_1 to 6_n, to cause the identifying information ID_T and control parameters DP that are stored in the non-contact IC tags 6_1 to 6_n to be read into the mobile terminal 8.

Note that, as described above, the identifying information ID_T and controlling parameters DP that are read in from the non-contact IC tags 6_1 to 6_n are each stored in the storing portion 83 of the mobile terminal 8.

Once reading of all of the non-contact IC tags 6_1 to 6_n has been completed, then the control parameters DP are set in the controllers 7_1 to 7_n through radio communication between the mobile terminal 8 and the controllers 7_1 to 7_n (S202). Specifically, the control parameters DP that are stored in the mobile terminal 8 are transmitted to the targeted controllers 7_1 to 7_n through the operator bringing the mobile terminal 8 sequentially into proximity with all of the controllers 7_1 to 7_n.

Once setting of the control parameters DP has been completed for all of the controllers 7_1 to 7_n, through repetitively carrying out the procedure of Step S202, described above, for all of the individual controllers 7_1 to 7_n, then the procedure for setting up the control parameters DP in the individual controllers 7_1 to 7_n is complete.

The procedure in Step S202, described above, will be explained in detail here.

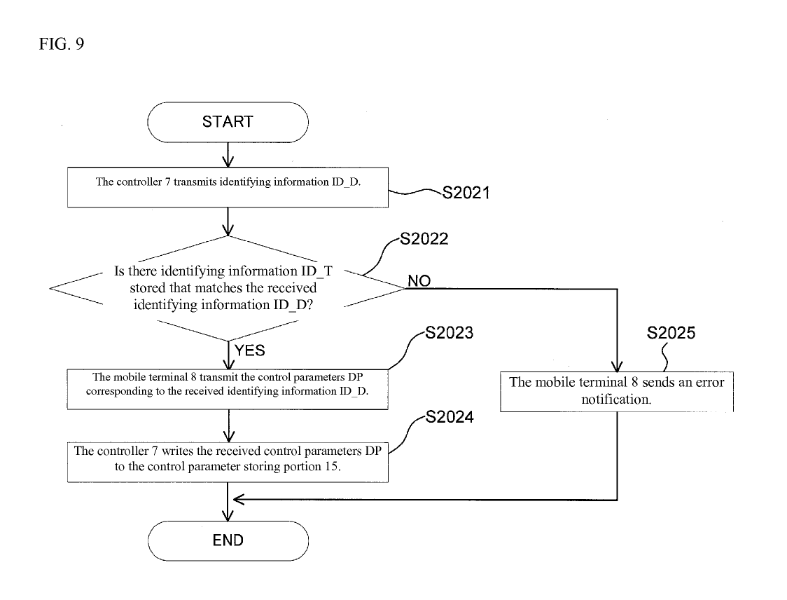

FIG. 9 is a diagram illustrating a specific processing procedure of Step S202 in FIG. 8.

First, for example, negotiation between the controller 7 and the mobile terminal 8 is carried out, and if in a state wherein the targeted communication can be carried out, then the controller 7 reads out and transmits the identifying information ID_D that is stored in the identifying information storing portion 14 (S2021). The mobile terminal 8 receives the identifying information ID_D that is transmitted from the controller 7, and evaluates whether or not identifying information ID_T that matches the received identifying information ID_D is stored in the storing portion 83 (S2022).

If, in Step S2022, the evaluation is that, in the storing portion 83, there is no identifying information ID_T that matches the identifying information ID_D that has been received, then the mobile terminal 8 provides notification that there is an error (S2025), as described above, and terminates the series of processes.

On the other hand, if, in Step S2022 the evaluation is that identifying information ID_T that matches the identifying information ID_D that has been received is stored in the storing portion 83, then the mobile terminal 8 reads out, from the storing portion 83, the control parameters DP corresponding to the identifying information ID_T that matches the identifying information ID_D that has been received, and, as a response to the transmission of the identifying information ID_D by the mobile terminal 8, transmits control parameters DP that have been read out (S2023). The controller 7 receives the control parameters DP that have been transmitted from the mobile terminal 8, and stores them in the identifying information storing portion 14 (S2024). Thus, the control parameters DP are set in the controller 7.

The controller according to the Another Example, described above, as with the controller 1 said for the Example, is able to eliminate the need for the manual input by the operator and the PC loader, such as is conventional, thereby enabling a reduction in operator time and a reduction in costs, when setting up the control parameters in the regulator.

Moreover, in the controller according to the Another Example, identifying information is transmitted to the mobile terminal that has read out control parameters and identifying information from the non-contact IC tag, and, as a response, the control parameters that have been received are written to the controller, thus making it possible to set the information from the non-contact IC tag into the targeted controller alone. This makes it possible to prevent the operator from causing the information from the non-contact IC tag to be read in erroneously to another controller when consoles for a plurality of controllers are arranged together in one place.

Moreover, because the control parameters are set up in the regulator through a mobile terminal that has read in the control parameters and the identifying information from the non-contact IC tags in advance, there is no need for the operator to remove the non-contact IC tags from the pallets, or the like, thereby making possible to further reduce the load on the operator.

While the invention created by the present inventors has been explained in specifics above based on examples, the present invention is not limited thereto, but rather may of course be modified in a variety of ways in a scope that does not deviate from the spirit or intent thereof.

For example, in the Example and Another Example, the identifying information and control parameters may be stored in non-contact IC cards rather than in non-contact IC tags, and the information from the non-contact IC cards may be read in by the non-contact communicating portion 11 or the mobile terminal 8.

Moreover, in the Another Example a case was illustrated wherein the radio communication between the mobile terminal 8 (the communicating portion 81) and the controller 7 was achieved through NFC, there is no limitation thereto, but rather it may be achieved through, for example, a wireless LAN, through IrDA (Infrared Data Association), or Bluetooth (registered trademark).

Moreover, while in the Example and the Another Example cases wherein the regulators 1 and 7 were temperature regulators were illustrated, the regulators may instead have functions for regulating pressure, flow rates, or the like, instead of temperature.

1: A controller comprising:
an identifying information storage storing unique identifying information;
a non-contact communicator receiving, through radio communication, a control parameter indicating a control condition for a controlled device and identifying information for a controller that is to control the controlled device based on the control parameter;
a control parameter storage storing the control parameter;
a control signal generator generating a control signal that controls the controlled device based on the control parameter stored in the control parameter storage;
an evaluator evaluating whether or not identifying information received by the non- contact communicator matches identifying information stored in the identifying information storage; and
a writing controller writing to the control parameter storage of the control parameter received by the non-contact communicator; wherein:
the writing controller writes, to the control parameter storage, the control parameter received by the non-contact communicator if the identifying information received through the non-contact communicator matches identifying information stored in the identifying information storage, and does not write, to the control parameter storage, the control parameter received through the non-contact communicator if the identifying information that is stored in the identifying information storage does not match the identifying information received through the non-contact communicator.

2: A controller comprising:
an identifying information storage storing unique identifying information;
a control parameter storage storing a control parameter indicating a control condition for a controlled device;
a control signal generator generating a control signal that controls the controlled device based on the control parameter stored in the control parameter storage;
a communicator carrying out radio communication with an external device;
a communication controller controlling communication through the communicator, and that controls writing, to the control parameter storage, of the data received through the communicating portion; wherein:
the communication controller transmits the identifying information, stored in the identifying information storing portion, through the communicator, and, when a control parameter is received as a response to the transmission of the identifying information, writes the received control parameter into the control parameter storage.
